(19) United States
(12) Patent Application Publication
(10) Pub. No.: US 2009/0189728 A1
(43) Pub. Date: Jul. 30, 2009

(54) AMORPHOUS TRANSFORMER FOR ELECTRIC POWER SUPPLY

(76) Inventors: Kazuyuki Fukui, Tainai (JP); Koji Yamashita, Tainai (JP); Yuichi Ogawa, Tokyo (JP); Masamu Naoe, Tokyo (JP); Yoshihito Yoshizawa, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/280,810

(22) PCT Filed: Feb. 27, 2007
(86) PCT No.: PCT/JP2007/053581

§ 371 Date: Nov. 13, 2008

(30) Foreign Application Priority Data
Feb. 28, 2006 (JP) 2006-051754

(51) Int. Cl. H01F 17/04; C22C 45/02; H01F 1/04

(52) U.S. Cl. 336/221; 148/403; 148/304

(57) ABSTRACT

This invention provides an amorphous transformer for electric power supply, using a magnetic core formed of an amorphous alloy material, which, as compared with the conventional amorphous alloy material, has a lower annealing temperature and a higher level of magnetic properties. The amorphous transformer for electric power supply is provided with a magnetic core of a thin band of an amorphous alloy and a winding wire. The iron core has been annealed under such conditions that the iron core center part temperature during annealing after iron core molding is 300 to 340° C. and the holding time is not less than 0.5 hr. Further, for the iron core, the magnetic field intensity during annealing after the iron core molding is not less than 800 A/m.

### TECHNICAL FIELD

The present invention relates to a transformer containing an iron core composed of an amorphous alloy thin band and a winding, and particularly to an amorphous transformer for electric power supply characterized by the material of the iron core and the annealing treatment of the iron core.

### BACKGROUND ART

Conventionally, an amorphous transformer using an amorphous alloy as the material of the iron core is known. In this amorphous transformer, amorphous alloy foil bands are laminated and bent in a U-shape, and both ends of the amorphous alloy foil bands are butted or overlapped to provide a wound iron core, and the iron loss can be smaller than that of transformers using conventional electromagnetic steel sheets.

However, in the wound iron core structure, stress to worsen the magnetic properties occurs when the material is bent. Therefore, it is necessary to subject the iron core to annealing treatment in a magnetic field to release the stress in order to improve the above magnetic properties. By performing annealing treatment, recrystallization starts inside the material to lead to embrittlement. This applies not only to amorphous alloys but also to electromagnetic steel sheets. At this time, the annealing conditions have a connection with the composition of the alloy, and for Metglas (R) 2605SA1 of a conventional material, annealing is performed at a temperature of more than 330° C. for 30 minutes or more. Also, in Patent Document 1, the annealing conditions are decided using an original formula.

Patent Document 1: JP-A-58-34162

### DISCLOSURE OF THE INVENTION

### Problem to be Solved by the Invention

An amorphous alloy having a composition different from that of conventional common materials wherein the amorphous ally can provide a high saturation magnetic flux density and a lower loss has been developed by one of the applicants of this application, and this invention has been filed as the patent application (Japanese Patent Application No. 2005-62187). In the patent application for this new material, the composition is mainly described, and detail annealing conditions are not described. However, the composition of the new material is different from that of the conventional common materials. In the circumstances, there is a possibility that the annealing treatment of the above amorphous alloy is different from conventional annealing treatments.

Therefore, it is an object of the present invention to select the optimal annealing conditions for the new material and provide an amorphous transformer for electric power supply having lower loss than transformers using conventional amorphous alloys.

### Means for Solving the Problem

The present invention is an amorphous transformer for electric power supply containing an iron core composed of an amorphous alloy thin band and a winding, wherein the iron core has been subjected to annealing treatment in which the temperature of the center portion of the iron core during annealing after the iron core is formed and shaped is 300 to 34020 C. and the holding time is 0.5 hr or more.

Also, in the amorphous transformer for electric power supply, the magnetic field strength of the iron core of the present invention during annealing after the iron core is formed and shaped is 800 A/m or more.

Further, the amorphous alloy thin band of the present invention preferably contains an amorphous alloy composed of an alloy composition expressed by FeₐSi_{b}B_{c}C_{d} (Fe: iron, Si: silicon, B: boron, and C: carbon) in which 80≦a≦83%, 0<b≦5%, 12≦c≦18%, and 0.01≦d≦3% in atomic % and an unavoidable impurity. The amorphous alloy thin band having this composition has a high Bs (i.e. saturation magnetic flux density) and an excellent squareness property, so that even if the annealing temperature is low, a magnetic core having properties superior to those of conventional materials can be provided. An amorphous alloy thin band, in which when the concentration distribution of C is measured from the free surface and roll surface of the amorphous alloy thin band to the inside, the peak value of the concentration distribution of C is at a depth in the range of 2 to 20 nm, is preferable as the amorphous alloy thin band for the amorphous transformer for electric power supply.

The reasons for limiting the composition will be described below. Hereinafter, the symbol described as “%” expresses atomic %.

If the symbol “a” representing the amount of Fe is less than 80%, saturation magnetic flux density sufficient as the iron core material is not obtained. Also, if “a” is more than 83%, the thermal stability decreases, and therefore a stable amorphous alloy thin band cannot be manufactured. In view of the circumstances, 80≦a≦83% is preferable. Further, 50% or less of the amount of Fe may be substituted by one or two of Co and Ni. The substitution amount is preferably 40% or less for Co and 10% or less for Ni to obtain a high saturation magnetic flux density.

Regarding the symbol “b” representing the amount of Si which is an element that contributes to an amorphous forming ability, it is preferably 5% or less to improve a saturation magnetic flux density.

Regarding the symbol “c” representing the amount of B, it most contributes to an amorphous forming ability. If “c” is less than 8%, the thermal stability decreases. Even if “c” is more than 18%, no improvement effect such as an amorphous forming ability is seen. Also, “c” is preferably 12% or more to maintain the thermal stability of the amorphous having a high saturation magnetic flux density.

C is effective for improving squareness and saturation magnetic flux density. However, if symbol “d” representing the amount of C is less than 0.01%, the effect is little. If “d” is more than 3%, the embrittlement occurs, and the thermal stability decreases.

Also, 0.01 to 5% of one or more elements of Cr, Mo, Zr, Hf, and Nb may be included, and 0.50% or less of at least one or more elements from Mn, S, P, Sn, Cu, Al, and Ti may be contained as an unavoidable impurity.

Further, in the amorphous transformer for electric power supply, the symbol “b” representing the amount of Si in atomic % and the symbol “d” representing the amount of C satisfy the relation of b≦(0.5×a−36)×d^{1/3} in the amorphous alloy thin band of the present invention.

Also, the present invention is the amorphous transformer for electric power supply wherein a saturation magnetic flux density of the amorphous alloy thin band after annealing is 1.60 T or more.

The present invention is the amorphous transformer for electric power supply wherein the magnetic flux density of the iron core at an external magnetic field of 80 A/m after annealing is 1.55 T or more.

Further, the present invention is the amorphous transformer for electric power supply wherein the magnetic flux density of the iron core after annealing is 1.4 T, and the iron loss W_{14/50} of a toroidal sample of the iron core at a frequency of 50 Hz is 0.28 W/kg or less.

Also, the present invention is the amorphous transformer for electric power supply wherein the fracture strain ε of the iron core after annealing is 0.020 or more.

### Advantages of the Invention

According to the present invention, for an amorphous alloy having a composition of FeSiBC (Fe: iron, Si: silicon, B: boron, and C: carbon) different from that of conventional common materials wherein the amorphous alloy has a high saturation magnetic flux density and a lower loss, an amorphous transformer for electric power supply containing a magnetic core with properties superior to those of conventional materials even if the annealing temperature is low can be provided.

### BEST MODE FOR CARRYING OUT THE INVENTION

The best mode for carrying out the present invention will be described.

The examples of amorphous transformers for electric power supply according to the present invention will be described using the drawings.

### EXAMPLE 1

Example 1 will be described. An amorphous transformer for electric power supply according to this example contains an iron core, in which amorphous alloy foil bands are laminated and bent in a U-shape and both ends of the amorphous alloy foil bands are butted or overlapped, and a winding.

An amorphous alloy thin band used for the iron core of this example contains an amorphous alloy composed of an alloy composition expressed by FeₐSi_{b}B_{c}C_{d} (Fe: iron, Si: silicon, B: boron, and C: carbon) in which 80≦a≦83%, 0<b≦5%, 12≦c≦18%, and 0.01≦d≦3% in atomic % and an unavoidable impurity. When the concentration distribution of C is measured from the free surface and roll surface of the amorphous alloy thin band to the inside, the peak value of the concentration distribution of C is at a depth in the range of 2 to 20 nm. Annealing has been performed, with the temperature of the center portion of the iron core during annealing after the iron core is formed and shaped being 320±5° C. and the holding time being 60±10 minutes. The magnetic field strength during annealing after the iron core is formed and shaped is 800 A/m or more.

In the amorphous alloy thin band of this example, “b” representing the amount of Si in atomic % and “d” representing the amount of C preferably satisfy the relation of b≦(0.5×a−36)×d^{1/3}. As shown in FIG. 4, the amount of C is depended on to some degree, but by decreasing b/d with respect to a constant amount of C, a composition with a high degree of stress relaxation and a high magnetic flux saturation density is provided, which is most suitable as the material of a transformer for electric power. Further, the embrittlement, the surface crystallization, and the decrease in thermal stability, which occur when a high amount of C is added, are suppressed.

The magnetic flux density of the iron core of this example at an external magnetic field of 80 A/m after annealing is 1.55 T or more. Also, the magnetic flux density of the iron core of this example after annealing is 1.4 T, and the iron loss W_{14/50} of a toroidal sample of the iron core of this example at a frequency of 50 Hz is 0.28 W/kg or less. The fracture strain ε of the iron core of this example after annealing is 0.020 or more.

The annealing conditions of the iron core of the amorphous transformer of this example will be described. As the iron core of the example, an amorphous alloy composed of an alloy composition expressed by FeₐSi_{b}B_{c}C_{d} (Fe: iron, Si: silicon, B: boron, and C: carbon) in which 80≦a≦83%, 0<b≦5%, and 12≦c≦18% in atomic % was used. Also, as a comparative example, an amorphous alloy composed of an alloy composition expressed by FeₐSi_{b}B_{c}C_{d} (Fe: iron, Si: silicon, B: boron, and C: carbon) in which 76≦a≦81%, 5<b≦12%, 8≦c≦12%, and 0.01≦d≦3% in atomic % and an unavoidable impurity was used.

Annealing treatment was carried out under different conditions. The annealing time was 1 hour. In FIG. 1, the horizontal axis is annealing temperature, and the vertical axis is a holding force (Hc) obtained after the treatment. In FIG. 2, the horizontal axis is annealing temperature, and the vertical axis is a magnetic flux density obtained when the magnetizing force during annealing is 80 A/m, which is referred to as B80. For both of the amorphous alloys used in the iron core of the example and the iron core of the comparative example, the obtained magnetic properties change according to the annealing conditions. For the amorphous alloy of this example, compared with the amorphous alloy of the comparative example, the holding force (Hc) can be lower even if the annealing temperature is low. For the amorphous alloy of the example, an annealing temperature of 300 to 340° C. is preferable, and particularly an annealing temperature in the range of 300 to 330° C. is more preferable. Also, for the amorphous alloy of the example, compared with the amorphous alloy of the comparative example, B80 can be higher, and moreover the good magnetic properties can be obtained even if the annealing temperature is low. For the amorphous alloy of the example, an annealing temperature of 310 to 340° C. is preferable. Therefore, for the amorphous alloy of the example, the annealing temperature is preferably 310 to 33020 C. in order that both magnetic properties are good. This annealing temperature is lower than that of the amorphous alloy in the comparative example by about 20 to 30° C. The lowering of the annealing temperature leads to the lowering of the energy consumption used in the annealing treatment, and therefore the amorphous alloy of the example is also excellent in this respect. For the amorphous alloy of the comparative example, good magnetic properties are not obtained at this annealing temperature. Also, the annealing time is preferably 0.5 hour or more. If the annealing time is less than 0.5 hour, the sufficient properties cannot be obtained. Also, if the annealing time is more than 150 minutes, the properties according to the consumed energy cannot be obtained. Particularly, the annealing time is preferably 40 to 100 minutes and more preferably 50 to 70 minutes.

FIG. 3 shows the property (iron loss) of the transformer containing the iron core of the amorphous alloy of the example, which is the results of the various annealing conditions according to five patterns A to E. Here, patterns C and D are examples using the same material as that of the above comparative example or a material close to that of the above comparative example, and the iron loss of both patterns is worse than that of patterns A and B, which can be said to be the same as the tendency confirmed in FIG. 1. Patterns A and B are examples in which the applied magnetic field strength during annealing is changed for comparison. It is found that the iron loss is almost unchanged even when a magnetic field strength of 800 A/m or more is applied. However, it is necessary to flow much current in pattern B, and therefore the optimum annealing conditions are pattern A. Also, it has been found that the iron loss increases at an applied magnetic field strength of less than 800 A/m. Also, it has been found that although the iron loss in pattern E is slightly inferior to that in pattern A, that pattern E is suitable as the annealing conditions.

### EXAMPLE 2

Next, Example 2 will be described. The amorphous transformer of this Example 2 differs from Example 1 in the material of the amorphous alloy thin band. The amorphous alloy thin band of Example 2 contains an amorphous alloy composed of an alloy composition expressed by FeₐSi_{b}B_{c}C_{d} (Fe: iron, Si: silicon, B: boron, and C: carbon) in which 80≦a≦83%, 0<b≦5%, 12≦c≦18%, and 0.01≦d≦3% in atomic % and an unavoidable impurity. The saturation magnetic flux density of the amorphous alloy thin band of Example 2 after annealing is 1.60 T or more. Numerical values other than these are similar to those of Example 1. The magnetic properties and the like corresponding to annealing conditions were also substantially similar to those of Example 1.

### BRIEF DESCRIPTION OF THE DRAWINGS

FIG. 1 is an explanatory drawing of the annealing conditions and magnetic property 1 of the developed material of Example 1.

FIG. 2 is an explanatory drawing of the annealing conditions and magnetic property 2 of the developed material of Example 1.

FIG. 3 is an explanatory drawing of the annealing conditions and magnetic property of the amorphous transformer containing the iron core of the developed material of Example 1.

FIG. 4 is an explanatory drawing showing the relationship between b representing the amount of Si and d representing the amount of C, and the relationship between them and the degree of stress relaxation and fracture strain.

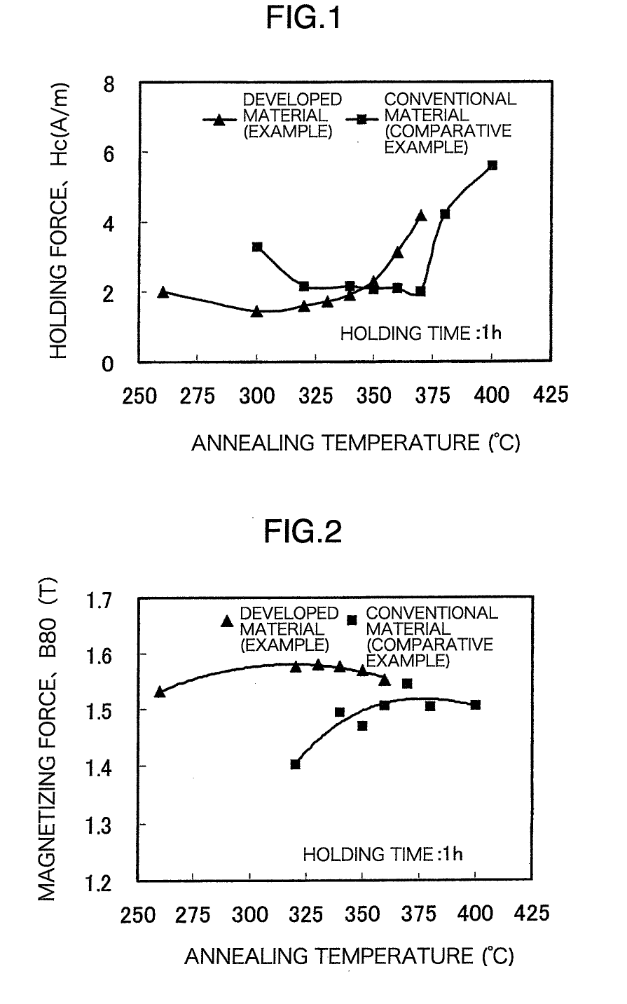

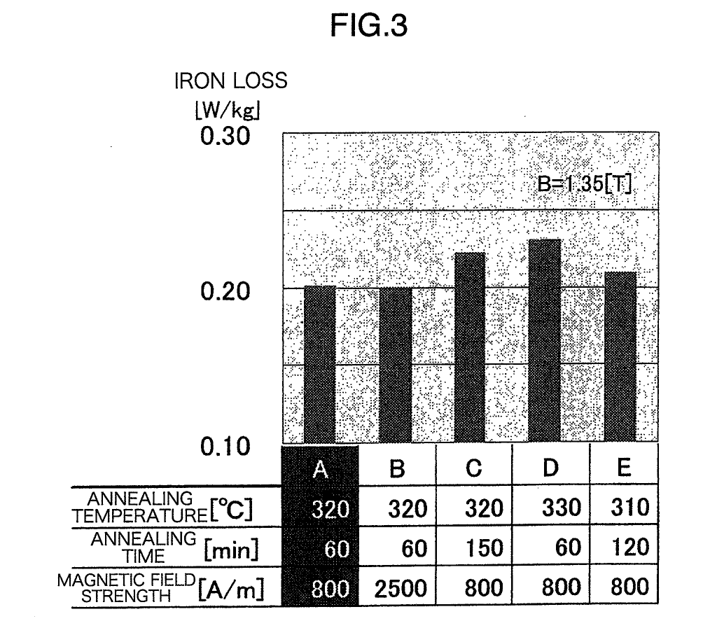

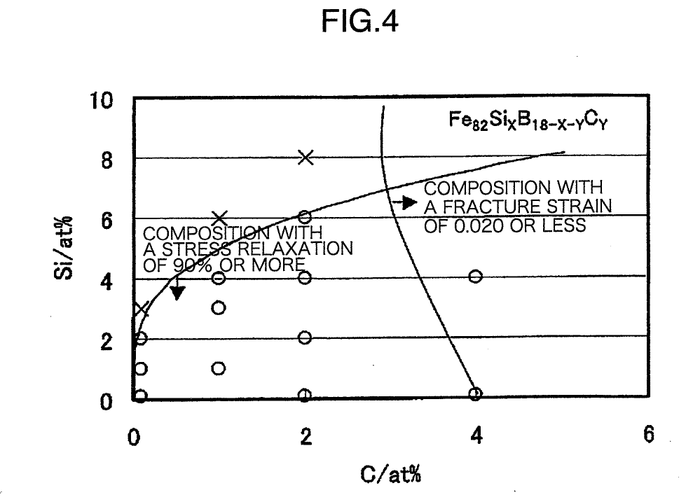

1. An amorphous transformer for electric power supply comprising an iron core comprising an amorphous alloy thin band and a winding, wherein the iron core is subjected to an annealing treatment in which a temperature of a center portion of the iron core during annealing after the iron core is formed and shaped is 300 to 340° C. and a holding time is 0.5 hour or more.

2. The amorphous transformer for electric power supply according to claim 1, wherein a magnetic field strength of the iron core during annealing after the iron core is formed and shaped is 800 A/m or more.

3. The amorphous transformer for electric power supply according to claim 1 or 2, wherein the amorphous alloy thin band comprises an amorphous alloy comprising an alloy composition expressed by FeₐSi_{b}B_{c}C_{d} (Fe: iron, Si: silicon, B: boron, and C: carbon) in which 80≦a≦83%, 0<b<5%, 12≦c≦18%, and 0.01≦d≦3% in atomic % and an unavoidable impurity.

4. The amorphous transformer for electric power supply according to claim 3, wherein in the alloy composition of the amorphous alloy thin band b representing the amount of Si in atomic % and d representing the amount of C satisfy a relation of b≦(0.5×a−36)×d^{1/3}.

5. The amorphous transformer for electric power supply according to claim 1 or 3, wherein a saturation magnetic flux density of the amorphous alloy thin band after annealing is 1.60 T or more.

6. The amorphous transformer for electric power supply according to any one of claims 1 to 5, wherein when a concentration distribution of C is measured from a free surface and roll surface of the amorphous alloy thin band to inside, a peak value of the concentration distribution of C is at a depth in the range of 2 to 20 nm.

7. The amorphous transformer for electric power supply according to any one of claim 1 to claim 5, wherein a magnetic flux density of the iron core at an external magnetic field of 80 A/m after annealing is 1.55 T or more.

8. The amorphous transformer for electric power supply according to any one of claims 1 to 5, wherein a magnetic flux density of the iron core after annealing is 1.4 T, and an iron loss W_{14/50} of a toroidal sample of the iron core at a frequency of 50 Hz is 0.28 W/kg or less.

9. The amorphous transformer for electric power supply according to any one of claims 1 to 5, wherein a fracture strain ε of the iron core after annealing is 0.020 or more.
